(19) United States
(12) Patent Application Publication
(10) Pub. No.: US 2021/0392248 A1
(43) Pub. Date: Dec. 16, 2021

(54) OPTICAL ASSEMBLY, OPTICAL INSTRUMENT AND METHOD

(71) Applicant: EARDLEY HOLDING AG, Basel (CH)

(72) Inventor: Peter KASZIAN, Vác (HU)

(21) Appl. No.: 17/283,519

(22) PCT Filed: Oct. 9, 2018
(86) PCT No.: PCT/EP2018/077422

§ 371 Date: Apr. 7, 2021

(51) Int. Cl. H04N 5/225; G02B 13/02; G02B 27/00

(52) U.S. Cl. CPC H04N 5/2254; G02B 27/0025; G02B 13/02; H04N 5/2253

(57) ABSTRACT

An optical assembly includes an intermediate image plane between a first lens unit and a second lens unit. The first lens unit may image an image from a first image plane into an enlarged real intermediate image in the intermediate image plane. A totality of possible ray paths through the first lens unit defines a first entrance region in the first image plane and a first exit region in the intermediate image plane. The second lens unit may image an image from the intermediate image plane into an enlarged real image in a second image plane. A totality of possible ray paths through the second lens unit defines a second entrance region in the intermediate image plane and a second exit region in the second image plane. The second entrance region comprises a first part of the first exit region and excludes a second part of the first exit region.

The present invention relates to an optical assembly. The invention further relates to an optical instrument comprising the optical assembly and a method for increasing the resolution of an optical instrument.

Passive optical instruments extend the capabilities of the eye, both in terms of its resolving power and its brightness perception. Differences in brightness, widely distributed spatial positions and color differences of objects are condensed into light information packets which, when transported with sufficient energy to great distances, can be received with telescopes and unfolded and presented as two-dimensional image information. Brightness, spatial and color information, condensed into a very small section of space, can be made available for further use with the aid of the microscope.

For the resolving power of the naked eye, the distance of 25 cm is considered the conventional visual range or reference visual range. Here, the eye can achieve the best spatial resolution for longer periods of time. If the object is held between 25 and 10 cm close to the eye, correspondingly better spatial resolution can be achieved for short periods of time. With relaxed eyes and longer distances, several meters to infinity, the typical angular resolution of the human eye is 1 angular minute.

Passive optical instruments are manufactured for different purposes. Their performance characteristics are basically optimized for the respective field of application. For example, the magnification of the telescope or microscope can usefully be increased until the angular resolution of the optical instrument is matched to that of the human eye. This is called useful magnification. Excessive magnification, on the other hand, where the visual contrast becomes too low, is called dead magnification. Classical imaging systems, such as telescopes, photo cameras and microscopes, basically have the structure of a specialized lens, specialized eyepiece and/or image sensor, where telephoto lenses or astro-lenses are specifically adapted for increasing distance and macro lenses, micro lenses and nano lenses are specifically adapted for increasing compression of optical information.

Between the objective and the eyepiece/storage medium, focal length-extending optics (so-called extenders), image relaying optics (so-called relay optics) and a projection lens can be mounted in the projection microscope. In all these cases, the quality, i.e. the resolution and contrast of the images, decreases. Although the image section can be reduced in this way, i.e. the object being viewed is enlarged, this is at the expense of image sharpness and richness of detail.

The task of the present invention was to provide an alternative device, respectively an alternative method, with which the optical resolution can be improved.

This task is solved by the features indicated in claim 1. Advantageous embodiments of the invention are indicated in dependent claims.

The present invention relates to an optical assembly comprising a first lens unit and a second lens unit. An intermediate image plane is defined between the first lens unit and the second lens unit. The first lens unit is adapted to image an image from a first image plane into an enlarged real intermediate image in the intermediate image plane. A set of possible ray paths through the first lens unit defines a first entrance region in the first image plane and defines a first exit region in the intermediate image plane. The second lens unit is adapted to image an image from the intermediate image plane into an enlarged real image in a second image plane. A set of possible ray paths through the second lens unit defines a second entrance region in the intermediate image plane and defines a second exit region in the second image plane. The second entrance region includes a first portion of the first exit region and excludes a second portion of the first exit region.

The first image plane is on the entrance side of the first lens unit and the second image plane is on the exit side of the second lens unit. An optical axis may extend from the entrance side of the optical assembly through the first lens unit and the second lens unit to an exit side of the optical assembly. In this case, the first image plane, the second image plane, and the intermediate image plane may be substantially perpendicular to the optical axis. The image in the first image plane may be formed by an object to be imaged, or it may in turn already be a real intermediate image generated by an optical system upstream of the optical assembly according to the invention. The enlarged real image formed in the second image plane has the desired increased resolution. This magnified real image created in the second image plane can be further magnified by further downstream optical elements, viewed through an eyepiece, or captured by an image sensor.

The first lens unit has a first entrance opening and a first magnification factor greater than 1, both of which influence the possible beam paths through the first lens unit. Similarly, the second lens unit has a second entrance aperture and a second magnification factor greater than 1, both of which affect the possible beam paths through the second lens unit. The first and second entrance regions, and the first and second exit regions, are planar regions within the respective plane in which they are defined. The first exit region and the second entrance region are both defined in the intermediate image plane. It is characteristic of the optical assembly according to the invention that only a part of the first exit region is overlapped by the second entrance region. At this overlapping area, it is possible to zoom into a detail, so to speak. Through the opening of the second lens unit only rays enter which belong to a section of the intermediate image. I.e., in contrast to a so-called relay optics, the entire intermediate image is not included in the subsequent second lens unit and an enlargement results from both lens units.

In the simplest case, the lens units can consist of a single lens. The lens units can also include mirrors as elements. The first lens unit and the second lens unit can each be constructed as a group of lenses. The two lens units, and possibly other optical elements, may be incorporated in a common outer tube. Such an outer tube may, for example, be grooved or blackened on the inside to minimize stray light within the optical assembly. In particular, elements may be provided which prevent indirect ray paths from the second part of the first exit area from entering the entrance opening of the second lens unit.

A cascade-like arrangement of several optical assemblies according to the invention is possible, as will be further explained below also in connection with embodiment examples. Due to its characteristic as a magnifying lens unit, the first entrance area comprises a first part of the first image plane and excludes a second part of the first image plane. With a suitable arrangement of a further lens unit in front of the first lens unit, an exit region of the further lens unit can be positioned with respect to the first image plane in such a way that the further lens unit and the first lens unit form a further optical assembly according to the invention, wherein the further lens unit has the role of the first lens unit of the further optical assembly and wherein the first lens unit of the first-mentioned optical assembly has the role of the second lens unit of the further optical assembly.

The optical assembly according to the invention could be called a multi-projection module, since it generates a real intermediate image—a projection—at least twice, namely in the intermediate image plane and in the second image plane.

As the inventor has recognized, when the optical assembly according to the invention is used, disadvantages of the prior art mentioned above, such as lower resolution or decreasing contrast in relay optics and/or extenders, do not occur when enlarging an object; on the contrary, the image quality of the original lens improves dramatically.

In one embodiment of the optical assembly, the first lens unit has a first focal length, and the second lens unit has a second focal length. The distance from the first lens unit to the intermediate image plane defines a first image width, and the distance from the second lens unit to the second image plane defines a second image width. According to the embodiment, a ratio of the first focal length to the first image width is in the range of 1:10 to 1:1000. Alternatively, or in combination with said feature, a ratio of the second focal length to the second image width is in the range of 1:10 to 1:1000.

In contrast to relay optics, in which a focal length to image width ratio is in the range 1:1 to 1:2, according to the present embodiment of the invention the image width is significantly greater than the focal length of the respective lens unit. The image width is to be understood as the distance from the last lens of the lens unit to the generated real intermediate image. For example, the first lens unit may have a focal length of 11 millimeters and be designed for an image width of 150 millimeters, i.e., have a focal length-to-image width ratio of approximately 1:13.6. In another example according to the embodiment, the first lens unit may have a very short focal length of 0.2 millimeters and be designed for an image width of 150 millimeters, thus having a focal length to image width ratio of 1:750. The second lens unit can have a focal length-to-focal length ratio according to one of the examples for the first lens unit.

The inventor has recognized that the imaging quality according to this embodiment is particularly high.

According to one embodiment, the ratio of the first focal length to the first image width and/or the ratio of the second focal length to the second image width is greater than or equal to 1:40.

The inventor has recognized that in this embodiment, magnification factors of the entire assembly in excess of 1000-times can be achieved while maintaining very high optical quality. This is particularly the case when both the ratio of the first focal length to the first image width and the ratio of the second focal length to the second image width are greater than or equal to 1:40.

According to one embodiment, the first and/or the second lens unit has a structure of an infinity corrected lens.

In particular, the first and/or second lens unit may have the structure of an infinity corrected microscope lens. By infinity corrected lens is meant a lens which is corrected to infinity with respect to at least one of the following aberrations:
chromatic aberration,
spherical aberration,
Astigmatism,
Coma.

In particular, several of said aberrations or all of said aberrations may be substantially corrected to infinity. Corrected to infinity means that the correction applies to every point behind the lens.

The inventor has recognized that this embodiment leads to surprisingly high imaging quality. Here, the correction of the aforementioned aberrations not only has an effect in the properties that one would expect—for example, in the correction of chromatic aberration in the reduction of unwanted color fringes at light-dark transitions—but surprisingly, the resolution achievable with the optical assembly is also greatly improved.

Strong improvements in achievable resolution are achieved by first and/or second lens units that have both an infinity corrected design, and where the ratio of focal length to image distance is also greater than or equal to 1:40.

According to one embodiment, the area of the first part of the first outlet region is at most one tenth of the area of the first outlet region.

According to this embodiment, the excluded second part of the first exit region is much larger than the first part of the first exit region corresponding to the second entrance region, which is further enlarged by the second lens unit. For example, the area of the first portion of the first exit region may be one-twentieth of the area of the first exit region or less.

In one embodiment, at least one further lens unit is arranged adjacent to the second lens unit and the at least one further lens unit is arranged to image an image from the intermediate image plane into an enlarged real image in a further image plane. Thereby, a totality of possible ray paths through the further objective unit defines a further entrance region in the intermediate image plane and defines a further exit region in the further image plane, wherein the further entrance region is different from the first entrance region.

In this embodiment, the further lens unit has the same function as the second lens unit, except that it is directed to a different entrance area. A plurality of such further lens units may be arranged side by side, for example in the manner of a compound eye of an insect. Each of the further lens units may be formed by a single lens, for example. The further entrance areas can be arranged in a hexagonal arrangement, for example, whereby the further entrance areas can slightly overlap with each other or with the second entrance area at the edge. In this way, image parts from a large part of the first exit area or from the entire first exit area can be recorded and further enlarged without gaps via a plurality of further lens units operating in parallel. This embodiment of the optical assembly can be incorporated, for example, in an optical instrument in which the further lens units are each arranged in front of a separate image sensor. The second lens unit and the further lens units may each be formed as a spherical lens or an aspherical lens in a micro lens array, wherein such a micro lens array may comprise 100 to 1000 individual micro lenses, i.e. further lens units arranged in parallel.

In one embodiment of the optical assembly, the first lens unit is configured such that the focal points formed by different radial regions of the first lens unit in the region of the intermediate image plane are less than 500 nanometers apart in the direction of an optical axis of the first lens unit, preferably less than 50 nanometers apart. Alternatively, or in combination with the said design of the first lens unit, the second lens unit is designed in such a way that the focal points formed by different radial regions of the second lens unit are less than 500 nanometers apart in the region of the second image plane in the direction of an optical axis of the second lens unit, preferably less than 50 nanometers apart.

The extent in the direction of the optical axis of the area in which the focus points of a lens unit fall, i.e. the extent of the area in which the paraxial focus, the center zone focus and the edge ray focus lie, is a measure of the spherical aberration. In this embodiment, the spherical aberration of the first lens unit and/or the second lens unit is corrected to a high or very high degree. The inventor has recognized that the quality of the image is surprisingly greatly improved by a low spherical aberration of the individual lens elements in the arrangement into an optical assembly according to the invention.

Low spherical aberration can be achieved by a suitably shaped aspherical lens or lens groups with at least one suitably shaped aspherical lens built into the lens unit. Another way to correct spherical aberration is to incorporate an aberration correction plate defined by thickness and refractive index with flat, parallel surfaces at a point in a lens unit where the rays converge or diverge.

The inventor has recognized that even optimization of the lens units with respect to spherical aberration to a degree where the focal points are closer together than 50 nanometers, i.e., closer than one-tenth of a typically imaged wavelength, surprisingly still leads to further increases in imaging quality by the optical assembly of the invention.

In addition, in this embodiment, but also in other embodiments, chromatic aberration may be corrected. This correction can be implemented as a so-called correction to infinity, i.e. in such a way that the correction applies to every point behind the lens.

In one embodiment, the optical assembly has a common mount for the first lens unit and the second lens unit.

In one embodiment of the optical assembly, the first lens unit and the second lens unit are movable relative to each other parallel to a common optical axis. In particular, the first lens unit and the second lens unit can be displaceable relative to each other within a range of 5 mm to 5 cm.

In this embodiment, for different object distances, the mutual position of the two lens units can be adjusted so that the common intermediate image plane comes to lie at a suitable distance from the two lens units.

In one embodiment of the optical assembly, the first lens unit and the second lens unit have identical characteristics.

In this embodiment, for example, two prefabricated lens units of identical design can be arranged one behind the other. This enables particularly cost-effective and simple production of the optical assembly.

One embodiment of the optical assembly comprises three or more lens units arranged in series, wherein each pair of adjacent lens units forms an optical assembly according to the invention, in particular wherein at least one pair of adjacent lens units forms an optical assembly according to one of said embodiments.

The basic element of the optical assembly, comprising two lens units, can be extended in a cascade. In each stage of the cascade, one lens unit magnifies a section of the real image, projects it to a defined distance, where the next lens unit projects a section of this real image again to a defined distance, and this is repeated over each stage of the cascading system. The real image of the last projection lens can, for example via a converging lens and/or an eyepiece, make the now highly magnified and detailed image of the object visible via a storage medium or the eye.

This embodiment is particularly suitable for total magnifications in the range of 1,000-times to 10,000-times.

Features of the embodiments of the optical assembly may be combined as desired, provided they are not contradictory. The task is further solved by an optical instrument according to claim 12.

The optical instrument according to the invention comprises an optical assembly according to the invention and further comprises an image sensor or an eyepiece, wherein the image sensor or the eyepiece is located downstream of the second lens unit.

In the case that an eyepiece is used, the resulting high-resolution image can be viewed directly by eye. The image sensor can, for example, have light-sensitive detector elements arranged in a matrix. Such image sensors are commercially available, for example, in the form of so-called charge-coupled device (CCD) sensors.

One embodiment of the optical instrument has a pinhole disposed on the entrance side of the optical assembly.

In this embodiment, the pinhole forms a virtual lens. The first stage of the optical instrument thus functions in the manner of a pinhole camera (camera obscura), in which no setting for a specific object distance is necessary.

One embodiment of the optical instrument further comprises an input lens disposed on the input side of the optical assembly.

The optical instrument according to this embodiment could be called a multiscope instrument. With the same basic structure of the input-lens-multiprojection-module-ocular or lens-multiprojection-module-image sensor, a universal passive optical instrument can be constructed, which is equally suitable for the fields of application astro-, tele-, macro-, micro- and nano-photography. In this context, multiprojection module means the optical assembly according to the invention.

As a simple technical realization of this embodiment, an arrangement of any input lens, a projection lens, a converging lens, and an eyepiece may be considered, with the individual elements arranged in the mentioned order along an optical axis.

In one embodiment of the optical instrument, the input lens is constructed as a telephoto lens.

This embodiment is suitable for imaging objects at a greater distance. In this embodiment, adjustment elements for focusing and for a zoom setting can be integrated in the telephoto lens. The subsequent optical assembly with first and second lens elements provide for further increase of the resolution.

In one embodiment of the optical instrument, the input lens has an entrance aperture greater than or equal to 90 millimeters and has a focal length greater than or equal to 400 millimeters.

The invention further relates to an optical instrument, in particular a microscope, which is constructed as an optical instrument according to the invention and wherein the input lens is constructed as a microscope lens.

This embodiment is particularly suitable for moving the input lens very close to an object to be imaged.

In one embodiment of the optical instrument, in particular a microscope, the input lens has an entrance aperture less than or equal to 6 millimeters and a focal length less than or equal to 10 millimeters.

In one embodiment, the optical instrument, in particular a microscope, further comprises a specimen carrier and an illumination unit, wherein, starting from the illumination unit, a light beam of the illumination unit illuminates one side of the specimen carrier, then passes the first and second lens units, and finally impinges on the image sensor, wherein the first lens unit and second lens unit, which are mounted on a focusing unit, are jointly displaceable at most in steps of at most 50 nanometers for focusing.

Features of the embodiments of the optical instrument, respectively of the microscope are arbitrarily combinable, if not contradictory.

The task is further solved by a method according to claim 20.

The method according to the invention is a method for optical imaging by an optical instrument with a first lens unit and a second lens unit. The first lens unit images a first image into an enlarged first intermediate real image. Further, the second lens unit images a partial area of the first intermediate real image into an enlarged second intermediate real image.

The optical assembly and the optical instrument or microscope according to the invention are suitable for carrying out the method according to the invention.

In all embodiments, the optical characteristics of the first lens unit and the second lens unit may correspond to the optical characteristics of a microscope lens. As an example, well-functioning combinations of first and second lens units are given below, each characterized by its focal length f and its entrance aperture D in millimeters:

| Example | first lens unit | second lens unit |
|---|---|---|
| No. 1 | f = 3.1 mm, D = 11.5 mm | f = 3.1 mm, D = 11.5 mm |
| No. 2 | f = 3.1 mm, D = 11.5 mm | f = 0.6 mm, D = 6.0 mm |
| No. 3 | f = 0.6 mm, D = 6.0 mm | f = 3.1 mm, D = 11.5 mm |
| No. 4 | f = 3.1 mm, D = 11.5 mm | f = 0.18 mm, D = 7.2 mm |
| No. 5 | f = 3.1 mm, D = 11.5 mm | f = 0.15 mm, D = 9.2 mm |

Example No. 1 is an embodiment in which the first and second lens units have the same characteristics. In all five tabulated examples, the entrance aperture D of the lens units is significantly larger than the focal length f. The quotient D/f in the examples given ranges from about 3.7 (see first lens unit in Examples Nos. 1, 2, 4 and 5) to about 61 (see second lens unit in Example 5).

Examples of embodiments of the present invention are explained in further detail below with reference to figures. It shows

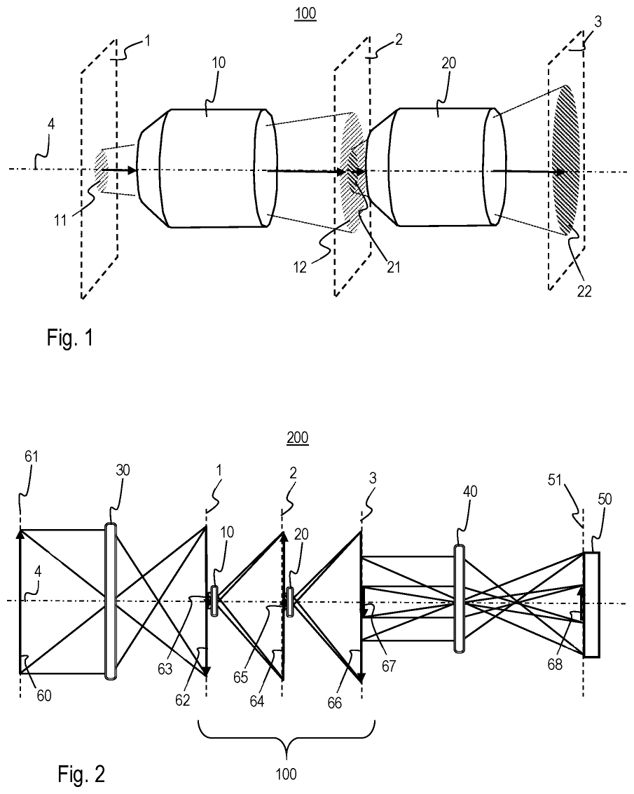

FIG. 1 is a schematic and simplified perspective view of an optical assembly according to the invention;

FIG. 2 schematic and simplified cross-sectional view of an embodiment of an optical instrument;

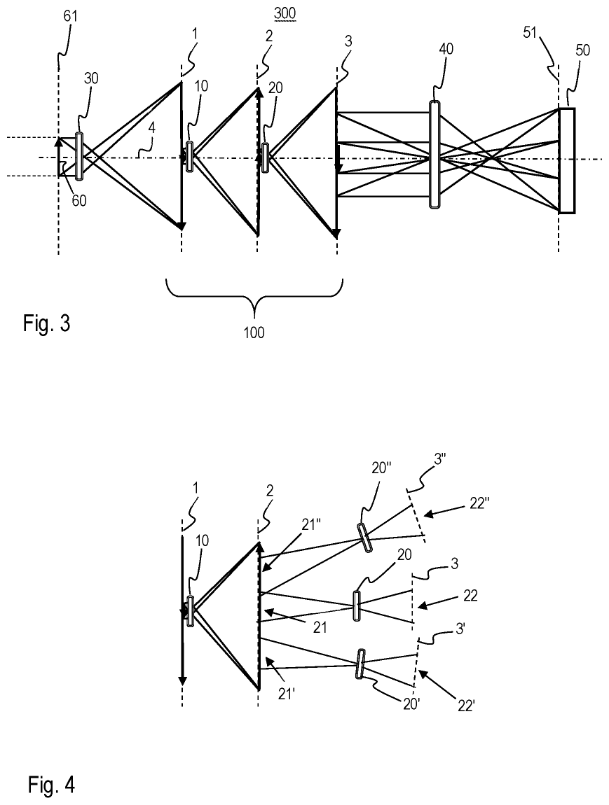

FIG. 3 schematic and simplified cross-sectional view of an embodiment of a microscope;

FIG. 4 schematically and simplified an embodiment with further lens units arranged next to the second lens unit.

FIG. 1 shows an optical assembly 100 according to the invention comprising a first lens unit 10 and a second lens unit 20. An optical axis 4 is drawn, which runs through both lens units. A first image plane 1 is defined on the input side of the first lens unit, an intermediate image plane 2 is defined between the two lens units, and a second image plane 3 is defined on the output side of the second lens unit. The planes mentioned are imaginary planes whose position is defined by the optical imaging properties and mutual position of the first and second lens units. The first lens unit 10 is arranged to image an image from a first image plane 1 into an enlarged real intermediate image in the intermediate image plane 2. A totality of possible ray paths through the first lens unit lies in a kind of entrance cone, which is indicated by dashed lines and which, intersected with the first image plane, defines a first planar entrance region 11. Similarly, an exit cone with possible ray paths in the intermediate image plane defines a first planar exit region 12.

The second lens unit 20 is arranged to map an image from the intermediate image plane 2 into an enlarged real image in a second image plane 3.

Thereby, a totality of possible ray paths through the second lens unit also defines a kind of entrance cone, indicated by dashed lines, and defines a second planar entrance region 21 intersected with the intermediate image plane. Similarly, a second planar exit region 22 is defined in the second image plane. The second entrance region 21 includes a first portion of the first exit region, hatched obliquely from upper left to lower right in the figure, and excludes a second portion of the first exit region. The second excluded region is hatched obliquely from lower left to upper right. To clarify the imaging steps, the first entry region 11 and the first exit region 12 are hatched in the same manner, and the second entry region 21 and the second exit region 22 are hatched in the same manner. This hatching does not represent any image content. Arrows on the optical axis 4 indicate the direction of the image.

FIG. 2 shows a schematic cross-section through an embodiment of an optical instrument. An optical assembly 100 is located in the section indicated by a curly bracket. The positions of the first image plane 1, the second image plane 3 and the intermediate image plane 2, as well as other planes, are each indicated by a dashed line. The real images or intermediate images as well as sections of the images and intermediate images are each indicated by arrows in the respective plane, the direction of the arrow indicating the position of the image. A viewed object 60 in an object plane is imaged by an input lens 30 in the first image plane 1. A section 63 of this image 62 is imaged into the intermediate image plane 2 by the first lens unit 10. A section 65 of the image 64 in the intermediate image plane is again imaged by the second lens unit 20 into the second image plane 3. The image 66 formed there is imaged through a converging lens 40 into an image sensor plane 51, behind which an image sensor 50, for example a CCD sensor, is arranged.

The figure shown is not to scale. In particular, the extension of the optical elements 10, 20, 30, 40 in the direction of the optical axis 4 can be significantly larger.

For example, the object 60 under consideration may be at a distance of 0.5 meters to infinity. The input lens 30 may have, for example, an input aperture of 90 millimeters or more. For example, the input lens 30 may have a focal length of 400 millimeters or more. The first 10 and second lens units 20 may both have, for example, the characteristics of a microscope lens. For example, the first 10 and second lens units 20 may be of the same design and have an input aperture of 6 millimeters or less and have a focal length of 10 millimeters or less.

FIG. 3 shows an embodiment of a microscope 300 analogous to FIG. 2. Here, the input lens 30 is a microscope lens. Accordingly, the distance from the object 60 to be imaged to the input lens is small compared to the diameter of the input lens. For example, the input lens 30 may have an input aperture of 6 millimeters or less and may have a focal length of 10 millimeters or less. The optical assembly 100, the converging lens 40, and the image sensor 50 may be constructed in the same manner as shown in FIG. 2.

FIG. 4 shows an embodiment in which at least one further lens unit is arranged next to the second lens unit. In this figure, two further lens units 20′ and 20″ are shown. They have the same function as the second lens unit 20, but each maps a different further entrance area 21′, 21″ onto a further exit area 22′, 22″ in a further image plane 3′, 3″. In the case shown, the inlet region 21′ is spatially separated from the inlet regions 21 and 21″. The entrance areas 21 and 21″ partially overlap. The image planes 3, 3′ and 3″ can have different positions and orientations in space as shown in this figure, but they can also be identical planes.

### LIST OF REFERENCE SIGNS

1 first image plane
2 intermediate image plane
3 second image plane
3′, 3″ further image planes
4 optical axis
10 first lens unit
11 first entrance area
12 first exit area
20 second lens unit
20′, 20″ further lens units
21 second entrance area
21′, 21″ further entrance areas
22 second exit area
22′, 22″ further exit areas
30 input lens
40 collective lens
50 image sensor
51 image sensor plane
60 object
61 object plane
62 real image in the first image plane
63 part of the real image 62
64 real intermediate image in the intermediate image plane
65 part of the real intermediate image 64
66 real image in the second image plane
67 part of the real image 66
68 real image in the image sensor plane
100 optical assembly
200 optical instrument
300 microscope

1. Optical assembly (100) comprising a first lens unit (10) and a second lens unit (20),
wherein an intermediate image plane (2) is defined between the first lens unit and the second lens unit,
wherein the first lens unit (10) is arranged to image an image from a first image plane (1) into an enlarged real intermediate image in the intermediate image plane (2) and wherein a totality of possible ray paths through the first lens unit defines a first entrance region (11) in the first image plane and defines a first exit region (12) in the intermediate image plane
wherein the second lens unit (20) is arranged to image an image from the intermediate image plane (2) into an enlarged real image in a second image plane (3), and wherein a totality of possible ray paths through the second lens unit defines a second entrance region (21) in the intermediate image plane and defines a second exit region (22) in the second image plane, and wherein the second entrance region (21) comprises a first part of the first exit region and excludes a second part of the first exit region.

2. The optical assembly of claim 1, wherein the first lens unit has a first focal length and the second lens unit has a second focal length, wherein the distance from the first lens unit to the intermediate image plane defines a first image width, wherein the distance from the second lens unit to the second image plane defines a second image width, and wherein a ratio of the first focal length to the first image width and/or a ratio of the second focal length to the second image width is in the range of 1:10 to 1:1000.

3. The optical assembly of claim 2, wherein the ratio of the first focal length to the first image width and/or the ratio of the second focal length to the second image width is greater than or equal to 1:40.

4. The optical assembly according to claim 1, wherein the first and/or the second lens unit has a structure of an infinity corrected lens.

5. The optical assembly according to claim 1, wherein the area of the first part of the first exit region is at most one tenth of the area of the first exit region.

6. The optical assembly according to claim 1, wherein at least one further lens unit is arranged adjacent to the second lens unit and the at least one further lens unit is arranged to image an image from the intermediate image plane (2) into an enlarged real image in a further image plane (3′, 3″) and wherein a totality of possible ray paths through the further lens unit defines a further entrance region (21′, 21″) in the intermediate image plane and defines a further exit region (22′, 22″) in the further image plane, wherein the further entrance region (21′, 21″) is different from the first entrance region (21).

7. The optical assembly according to claim 1, wherein the first lens unit (10) is configured in such a way that the focal points formed by different radial regions of the first lens unit are less than 500 nanometers apart in the region of the intermediate image plane (2) in the direction of an optical axis of the first lens unit, in particular are less than 50 nanometers apart, and/or wherein the second lens unit (20) is configured in such a way that the focal points formed by different radial regions of the second lens unit are less than 500 nanometers apart in the region of the second image plane (3) in the direction of an optical axis of the second lens unit, in particular are less than 50 nanometers apart.

8. The optical assembly according to claim 1, wherein the optical assembly comprises a common mount for the first lens unit (10) and the second lens unit (20).

9. The optical assembly according claim 1, wherein the first lens unit (10) and the second lens unit (20) are displaceable relative to one another parallel to a common optical axis (4), in particular are displaceable relative to one another within a range of 5 mm to 5 cm.

10. The optical assembly according to claim 1, wherein the first lens unit (10) and the second lens unit (20) have identical characteristics.

11. The optical assembly according to claim 1, wherein the optical assembly comprises three or more lens units (10, 20) arranged in series, and wherein each pair of adjacent lens units (10, 20) forms an assembly according to claim 1.

12. An optical instrument (200, 300) comprising an optical assembly according to claim 1, wherein the optical instrument further comprises an image sensor (50) or an eyepiece, and wherein the image sensor or the eyepiece is downstream of the second lens unit.

13. The optical instrument of claim 12, wherein the optical instrument further comprises a pinhole disposed on the entrance side of the optical assembly.

14. The optical instrument (200, 300) according to claim 12, wherein the optical instrument further comprises an input lens (30) disposed on the input side of the optical assembly.

15. The optical instrument (200) according to claim 14, wherein the input lens (30) is constructed as a telephoto lens.

16. The optical instrument (200) according to claim 14, wherein the input lens has an entrance aperture greater than or equal to 90 millimeters and has a focal length greater than or equal to 400 millimeters.

17. The optical instrument according to claim 14, wherein the input lens is constructed as a microscope lens.

18. The optical instrument of claim 14, wherein the input lens has an entrance aperture less than or equal to 6 millimeters and has a focal length less than or equal to 10 millimeters.

19. The optical instrument of claim 17, wherein the optical instrument further comprises a specimen carrier and an illumination unit, wherein, starting from the illumination unit, a light beam of the illumination unit illuminates one side of the specimen carrier, then passes through the first and second lens units, and finally impinges on the image sensor, wherein the first lens unit and second lens unit mounted on a focusing unit are displaceable together in steps of at most 50 nanometers for focusing.

20. A method of optical imaging by an optical instrument having a first lens unit and a second lens unit, wherein a first image is imaged into an enlarged first intermediate real image by the first lens unit and wherein a partial area of the first intermediate real image is imaged into an enlarged second intermediate real image by the second lens unit.
